(19) United States
(12) Patent Application Publication
(10) Pub. No.: US 2021/0402613 A1
(43) Pub. Date: Dec. 30, 2021

(54) METHOD FOR THE CONTROL OF A PROCESSING MACHINE OR OF AN INDUSTRIAL ROBOT

(71) Applicant: ESE-ROBOTICS GmbH, Jena (DE)

(72) Inventor: Steffen Eckardt, Waltersdorf (DE)

(21) Appl. No.: 17/473,667

(22) Filed: Sep. 13, 2021

Related U.S. Application Data
(63) Continuation of application No. PCT/EP2020/057010, filed on Mar. 13, 2020.

(30) Foreign Application Priority Data
Mar. 13, 2019 (DE) 10 2019 106 458.9

(51) Int. Cl. B25J 9/16; B25J 11/00; B25J 13/08

(52) U.S. Cl. CPC B25J 9/1697; B25J 13/089; B25J 11/007; B25J 9/1664

(57) ABSTRACT

A method for determining a position of a workpiece includes: acquiring image data of a workpiece via a camera which defines an optical axis parallel to an impact direction of a tool in a z-direction; searching for a reference structure of the workpiece using the acquired image data; determining a current position of at least one point of the structure in an x/y direction relative to the optical axis; comparing the current position with a nominal position thereof;

generating commands to place the tool to an area of the workpiece to be machined; and, determining the current position in the z-direction of the optical axis by determining a current x/y image size of the structure and by determining a distance of the structure from the camera by comparison with the known x/y size of the structure and considering the distance of the structure from the camera when generating the commands.

### CROSS REFERENCE TO RELATED APPLICATIONS

This application is a continuation application of international patent application PCT/EP2020/057010, filed Mar. 13, 2020, designating the United States and claiming priority from German application 10 2019 106 458.9, filed Mar. 13, 2019, and the entire content of both applications is incorporated herein by reference.

### TECHNICAL FIELD

The disclosure relates to a method for controlling a processing machine and/or an industrial robot.

### BACKGROUND

Industrial robots, for example processing machines in the form of welding fixtures, machines for machining as well as for the frictional and/or positive joining of workpieces, are used for the repeatable and efficient design of work processes. The positioning movements to be executed, for example of a tool in relation to a workpiece to be machined, are usually carried out on the basis of previously known coordinates. For this purpose, the workpiece is in a predetermined position and orientation.

It is also known from the prior art that a position, orientation and, if necessary, dimensions of a workpiece can be detected via a camera. Subsequent processing steps are then carried out in a controlled manner on the basis of the relative positions, orientations and/or dimensions determined in each case, as is known, for example, from U.S. Pat. No. 8,180,156 and WO 03/027783 A1.

Both workpieces with a predefined positioning and those without such a predefined positioning can have deviations in their dimensions and positions. Such deviations can arise, for example, during machining of the workpiece as a result of thermal expansion, mechanical loads or due to minor tolerances of infeed movements.

For example, in applications such as stud welding and projection welding, the workpieces and components are joined at fixed predefined coordinates. In the manufacturing process, for example, as mentioned above, deviations can occur that prevent compliance with the permissible tolerances. It is also possible that the industrial robot and other technical components of an infeed device are not located on a common substrate. In this case, considerable deviations of the actual positions of, for example, a tool of the industrial robot and the workpiece can sometimes occur. However, exceeding the permissible tolerances leads to rejects or requires costly reworking.

### SUMMARY

It is an object of the disclosure to provide solutions with which the position of a workpiece can be detected and any deviations that occur can be compensated. In addition, non-permitted states are to be detected as malfunctions and the result of a machining step is to be checked.

According to a first aspect of the disclosure, the problem is solved with a method for controlling a processing machine, in particular an industrial robot. Thereby, the method includes the step of acquiring image data of at least one image of a workpiece via a first camera, the optical axis of which is aligned parallel to a push direction (Z-direction) of a tool. The first camera may be arranged on the tool or on a tool holder and/or may be formed as a so-called mini camera. The push direction is considered to be a mainly executed feed direction of the tool towards a workpiece to be machined. For example, a drill is fed to a workpiece in a push direction, although the actual cutting movement of the drill is rotational about the longitudinal axis of the drill. The same applies mutatis mutandis to devices for screwing or for milling. Furthermore, in this sense, welding devices are also fed to a workpiece in a push direction. For example, for the purpose of stud welding, a stud to be welded is in push direction fed to a workpiece to which the stud is to be welded. The same applies to projection welding. A workpiece to be joined to another workpiece by projection welding is brought into contact with the latter. The workpieces are moved towards each other along the push direction.

Based on the captured image data, a reference structure of the workpiece is searched for in a further step of the process. Pattern recognition algorithms from the field of image processing can be used for this purpose.

Once a reference structure is detected, a current actual position of at least one reference point of the reference structure, preferably in an x/y plane extending orthogonally to the Z-direction relative to the optical axis of the first camera, is determined. The determined actual position can additionally be related to a known base coordinate system.

The determined current actual position of the reference structure is compared with a nominal position of the reference structure. Depending on the result of the comparison, control commands are generated to feed the tool to at least one area or location of the workpiece to be machined.

According to the disclosure, in a step of the method a determination of the current actual position of the reference structure in the Z-direction of the optical axis is carried out by determining a current x/y image size of the reference structure in the captured image and by determining a distance of the reference structure from the first camera by comparison with the known actual x/y size of the reference structure and taking this distance into account when generating the control command. The x/y image size in the image plane is correlated to the actual size of the reference structure in an object plane preferably parallel to the image plane, and taking into account the characteristics of the optical system used for image acquisition, the actual distance between the object plane and the image plane is determined. For example, the imaging scale of the optical system is taken into account. From this data, the current distance between the first camera and the object plane can be determined. Because of the known relative positional relationship of the first camera and the tool, the current distance of the tool from the object plane, and thus from the workpiece, can also be determined.

In one embodiment of the method, the reference structure is an opening, a body edge or an elevation of the workpiece. In this regard, at least one of a length dimension, a circumferential dimension, and/or a diameter of the reference structure is known. This known dimension serves as the real x/y size of the reference structure in the object plane and is the basis for determining the distance of the reference structure from the first camera.

It is also possible that, in a further embodiment, a virtual intersection of at least two structures of the workpiece is formed during execution of the method, and this intersection serves as a reference point for subsequent relative movements between the workpiece and the tool. For example, two converging body edges may be virtually extended and a common intersection point may be formed. The common intersection point is then used as reference point.

In order to check the success of a machining operation, for example welding a number of bolts or attaching a number of screws, image data of the workpiece can be acquired via a second camera under a recording direction oblique to the Z-direction. Based on the captured image data, a pattern recognition is performed at least in regions of the workpiece. Such pattern recognition can in turn be used via a comparison of a detected actual pattern with a nominal pattern for checking the success of one or more processing steps. If the actual pattern and the nominal pattern correspond sufficiently, it can be concluded that the workpiece has been machined in compliance with the permissible error tolerances. Therefore, a current machining state of the workpiece can be detected via pattern recognition and compared with a nominal machining state.

In particular, a welding device for stud welding, a welding device for projection welding, a device for screwing or a device for riveting can be used as a tool via the method according.

Machining of the workpiece may be performed with respect to the reference structure without including the reference structure in the machining operation. In further embodiments of the method, for example, a screw or a rivet is introduced into the reference structure, for example into a reference hole.

In order to carry out the method, the tool and/or the first camera can be brought into a detection position (also referred to as “pre-position”), from which image data of the workpiece are detected via the first camera. On the basis of the image data, at least one current center point of a reference structure formed, for example, as a reference opening is determined in that an outer shape of the mouth of the reference structure is virtually adapted to a circular shape and/or to the shape of an ellipse, and the center point of a circle or of an ellipse found in this way is determined. In this process, a circle or an ellipse is virtually searched for which approximates as well as possible a currently detected outer shape of the mouth of the reference structure. Each determined current center of the reference structure is compared with the current position of the optical axis.

Based on deviations of the position of the optical axis and the at least one current center point, control commands are generated and provided. The control commands are used to control a positioning device via which the tool is fed to the location or area of the workpiece to be machined.

In one possible embodiment of the method, a virtual adaptation of the outer shape of the reference structure to a circular shape and to the shape of an ellipse is performed and the respective current center point is determined. This is followed by the formation of a difference between the coordinates of the determined current center points. The difference formed is compared with a predetermined threshold value. If the threshold value is met, a control command is generated to adjust the position of the actual position and the target position of the first camera. In this case, one of the actual center points can be selected or the coordinates of the actual center points are averaged and the coordinates of a resulting center point are used. If the threshold value is exceeded, then the current center points deviate too much from each other and a warning signal is triggered. For example, this is the case if the reference structure in question is severely deformed. A warning signal is also triggered if the reference structure is partially or completely obscured.

In a further embodiment of the method, the process sequence is stopped and optionally a visual and/or audible warning is output if the reference structure is not detected or is detected incompletely.

The evaluation of the image data and the generation of the control commands can take place in real time in order to reduce the control times. The evaluation unit can optionally be accessed remotely in order to quickly determine its cause in the event of a fault.

According to a further aspect of the disclosure, a method is proposed for determining the position of a workpiece, in particular for controlling an industrial robot, including the step of acquiring image data of at least one image of the workpiece via a first camera. The first camera is arranged in particular in a stationary manner, for example within a production line, and can preferably be miniaturized.

Based on the captured image data, a reference structure of the workpiece is searched for in a further step of the method. For this purpose, pattern recognition algorithms from the field of image processing can be applied, which are executed on an evaluation unit.

Once a reference structure has been determined, a current actual position of at least one reference point of the reference structure, preferably in an x/y plane extending orthogonally to the optical axis of the first camera, relative to the optical axis of the first camera is determined. The determined actual position may additionally be related to a known base coordinate system, in the origin of which the first camera may preferably be positioned.

The determined current actual position of the reference structure is compared with a nominal position of the reference structure via the evaluation unit, and comparison data are generated which allow a conclusion to be drawn about the position of the workpiece in relation to the camera or to the known base coordinate system.

The reference structure may be a mark applied to the workpiece with structures that provide an orientation and have known dimensions. Alternatively, the reference structure may be an opening, gap, body edge, or elevation of the workpiece, with at least one of a length dimension, a circumferential dimension, and/or a diameter of the reference structure being known.

In one embodiment of the method, at least one further camera is provided via which further image data of the workpiece are acquired.

The first camera and the further camera(s) are preferably arranged stationary within a common (3D) base coordinate system.

On the basis of the captured further image data, at least one further reference structure of the workpiece and the current actual position of at least one reference point of the further reference structure in the x/y direction relative to the optical axis of the further camera or the further cameras are determined via the evaluation unit.

In a further process step, the current actual position of the further reference structure is compared with a nominal position of the further reference structure and further comparison data is generated.

The further comparison data are then additionally taken into account by the evaluation unit in the step of inferring the position of the workpiece.

Preferably, the optical axes of the first and at least one of the further cameras are not arranged in parallel. This allows the workpiece or parts of the workpiece to be captured from different viewing angles, whereby the spatial position of the workpiece within the base coordinate system can be determined with increased accuracy.

Additionally, it may be provided that the current actual position of the reference structure(s) in the z-direction of the optical axis (oa) of the camera or cameras is determined by determining a current x/y image size of the reference structure(s) in the image captured by the respective camera and determining a distance of the reference structure(s) from the camera by comparison with the known actual x/y size of the reference structure(s).

The determined actual position of the reference structure in the z-direction or the determined actual positions of the reference structures in the z-direction can finally also be taken into account by the evaluation unit when inferring the position of the workpiece, whereby the accuracy of the position determination can be further increased.

It can be further advantageously provided that—based on the determined position of the workpiece—control commands are generated via a control unit and that via the control commands either a tool is fed to at least one region or location of the workpiece to be machined or that a machining process with which the workpiece is currently being machined is interrupted or stopped, in particular because the determined position of the workpiece deviates significantly from a predetermined desired position of the workpiece. The significance of the deviation can, for example, be defined as a threshold value that is stored in the control unit.

Advantageously, a so-called digital twin of the workpiece is stored in the evaluation unit, and the evaluation unit can detect and visualize deviations from the captured image data via digital image processing and algorithms for pattern recognition, and take them into account accordingly for subsequent process steps/machining steps of the workpiece.

Both the position recognition and the pattern-based evaluation of the image data can be performed using machine intelligence. In a training phase, the intelligent evaluation software learns, for example using a CAD model of the workpiece and with the help of annotated training data, to recognize and classify positional deviations or pattern deviations independently and is then able to determine the correct position very reliably, for example, especially even if it was not given any fixed reference structures.

For the protection of the first camera in particular, a sleeve with an obliquely cut opening may be provided. The camera is arranged in the long extended part of the sleeve and thus protected from flying sparks etc. from one side.

The disclosure advantageously enables compensation of tolerance fluctuations that occur, for example, due to temperature. In addition or alternatively, deviations that occur, for example, as a result of mechanical tolerances of the workpiece, workpiece holder and/or feed devices and drives can be advantageously detected and taken into account in subsequent machining steps.

The method according to the disclosure can further be used to search for and determine a starting or starting position for machining processes such as gas-shielded welding and bonding. It is also possible to use the method to check a previously produced weld seam or an adhesive bead in its entire length or in sections.

### BRIEF DESCRIPTION OF THE DRAWINGS

The invention will now be described with reference to the drawings wherein:

FIG. 1 shows a flow chart of a first embodiment of the method according to the disclosure;

FIG. 2 shows a schematic representation of an example of a device suitable for carrying out the method;

FIG. 3 shows a schematic representation of a construction of a virtual reference point;

FIG. 4 shows a flow chart of a further embodiment of the method according to the disclosure;

FIG. 5A shows a schematic representation of a first camera with a protective sleeve in a frontal view; and,

FIG. 5B shows a schematic representation of the first camera with the protective sleeve in a side view.

### DESCRIPTION OF THE PREFERRED EMBODIMENTS

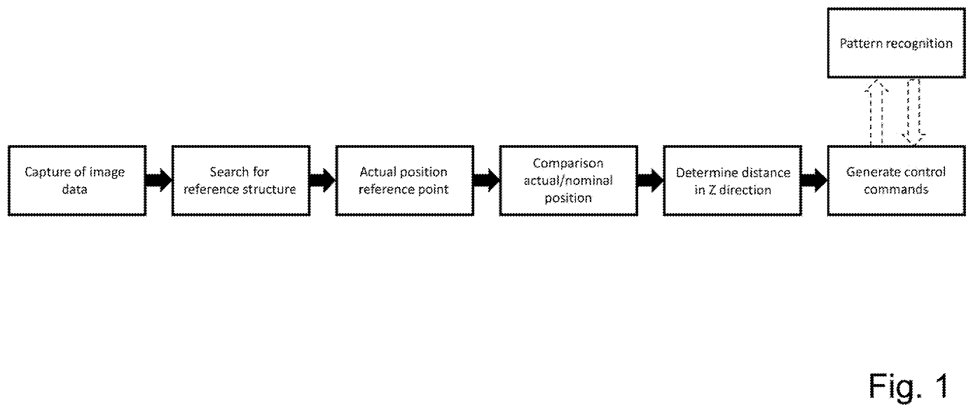

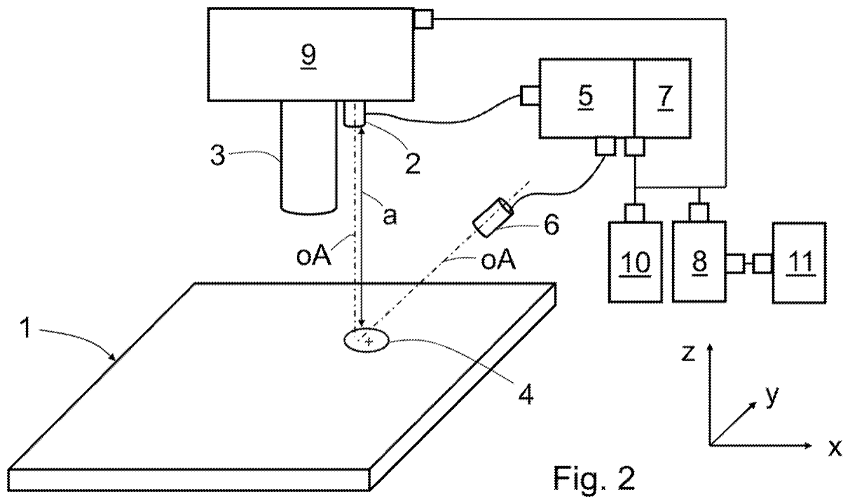

The essential process steps of a first embodiment of the process according to the disclosure are shown schematically in FIG. 1. With a view to FIG. 2, the process steps and technical units for carrying out the process are shown below.

The step of capturing image data of a workpiece 1 may be performed using a first camera 2. The first camera 2 may be a miniature camera. It is aligned with its optical axis oa parallel to a push direction of a tool 3, the push direction pointing in the direction of a z-axis z of a Cartesian coordinate system with the axes x, y and z.

A search for a reference structure 3 may be performed using image processing software housed in a computer unit 5. The computer unit 5 is, for example, a single board PC. In this way, decentralized image processing is possible, for example, whereby a corresponding arrangement for carrying out the method can have a modular structure. Moreover, retrofitting of the arrangement by replacing or reconfiguring the decentralized computer unit 5 is possible at low cost. In a further embodiment, the computer unit 5 can also be configured for image processing of a second camera 6 and be connected thereto in terms of data link.

The determination of at least one reference point + of the reference structure 4 on the basis of the captured image data, as well as a comparison of the determined actual position of the reference structure 4 and the reference point + with a nominal position, can be carried out via an evaluation unit 7. The evaluation unit 7 may be a physical or virtual sub-unit of the computer unit 5 or a separate unit.

The algorithms of the image processing of the computer unit 5 can be used for a determination of a distance a of the first camera 2 from the workpiece 1 in the Z-direction (push direction). For this purpose, detected and predetermined areas or sections of the reference structure 4 or the entire reference structure 4 are evaluated with respect to their x-/y-image size in the captured image and are related to a previously known actual x/y-size of the reference structure 4.

The determined information on the current positioning of the reference structure 4, in particular of the selected reference point +, as well as the determined distance a in the Z-direction enables the generation of control commands to feed the tool 3 to a desired position of the workpiece 1 and to machine the workpiece 1. Via an actuator 10, for example a robot, a tracking of the workpiece 1 and/or of the drive 9 can be effected on the basis of the data generated by the evaluation unit 7. The generation of the control commands can take place in a control unit 8. By effect of the control commands, the tool 3 is fed and moved via a drive 9 (also referred to generally as application). All data connections can be configured as plug-in connections (shown schematically), whereby a higher flexibility and an increased ease of maintenance are achieved.

All units may be connected to each other in a network. A database 11 may be connected to the control unit 8. Alternatively, the database 11 may be directly connected to the network.

Since the first camera 2 and the tool 3 have a known spatial relationship, the position of the first camera 2 relative to the reference point + can also be used to determine the current position of the tool 3 both, generally, for example within a base coordinate system with the axes x, y and z, and/or relative to the reference point +.

The optionally provided second camera 6 is directed obliquely towards the workpiece 1. The optical axes of the first camera 2 and the second camera 6 include, for example, an angle greater than zero and less than 90°. Via the second camera 6, image data of the workpiece 1 can be acquired under the recording direction oblique to the z-direction. Based on the captured image data from the first camera 2 and/or the second camera 6, a pattern recognition is performed at least in areas of the workpiece 1. In this regard, the computer unit 5 and the evaluation unit 7 are configured to acquire this image data and to execute the pattern recognition process (see FIG. 1). If the optional step of pattern recognition is carried out, the information obtained in the pattern recognition can be taken into account in the generation of the control commands or in a generation of further control commands in the sense of a closed-loop control, as illustrated by the arrows drawn with interrupted solid lines in FIG. 1.

In addition to checking the success of processing steps, the pattern recognition can serve to verify the presence of the reference structure 4 and to detect a permissible shape of the reference structure 4. In the event of a detected malfunction and/or an impermissible reference structure 4, an error signal may be output by the evaluation unit 7. Thereupon, a warning signal can be output, for example by the actuator 10, and optionally the tool 3 can be stopped via the control unit 8 and a corresponding control of the drive 9.

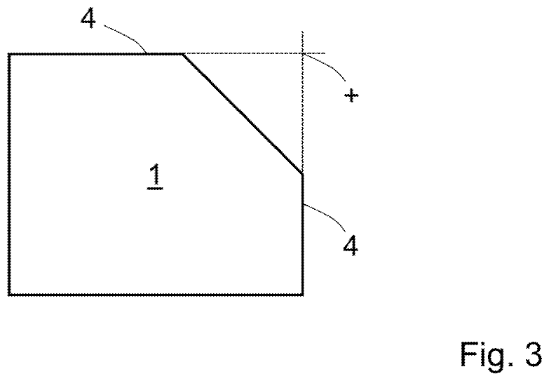

A reference point + may actually exist or may be determined virtually. For example, a reference point + may be the center of a circular reference structure 4 (see FIG. 2) or may be a virtual intersection point. FIG. 3 illustrates the construction of such a virtual intersection point. Two body edges of the workpiece 1 recognized as reference structures 4, which do not actually abut, are virtually extended. The virtual intersection point of the such virtually extended reference structures 4 is stored and used as reference point +.

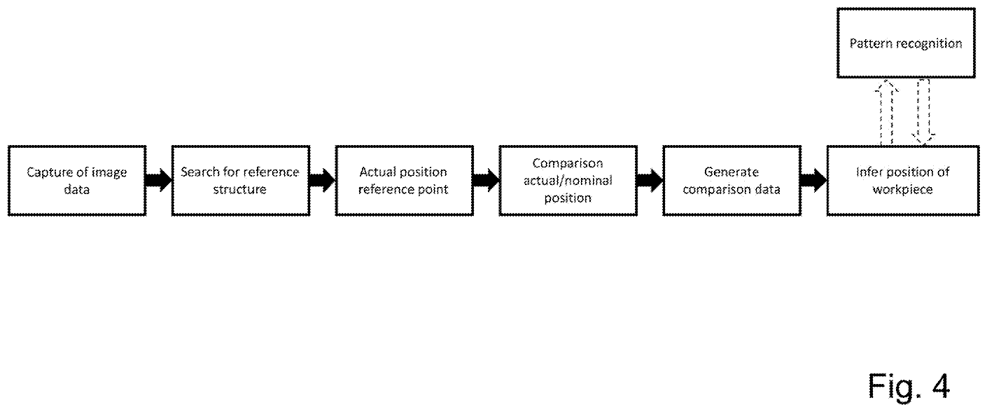

The essential process steps of a further embodiment of the process according to the disclosure are shown in FIG. 4. FIG. 2 can also be used here to explain the technical units necessary for carrying out the process.

The initial step of acquiring image data of a workpiece 1 is performed via the first camera 2. The first camera 2 may be set up as described above. The first camera 2 is fixedly arranged in a production line and forms the origin of a base coordinate system.

The search is performed via image processing software housed in the computer unit 5. The computer unit 5 is preferably set up as already described above. The computer unit 5 may also be configured for image processing of at least one further camera 6, and may be data-connected thereto. The further camera 6 is also arranged stationary at a known distance from the first camera 2. The further camera 6 is oriented at an angle greater than zero and less than 90° to the first camera 2 to the same object field as the first camera. Both cameras thus capture an equal image section from different perspectives. In other configurations, the optical axes of the first camera 2 and the further camera 6 are aligned in parallel and capture different image sections. For example, it may be provided that the first camera 2 captures a front side of the workpiece 1 and the second camera 6 captures a rear side of the workpiece 1.

The determination of at least one reference point + of the reference structure 4 on the basis of the acquired image data, as well as a comparison of the determined actual position of the reference structure 4 and the reference point + with a nominal position, is carried out via the evaluation unit 7, which generates comparison data therefrom.

Finally, the evaluation unit 7 is arranged to infer, based on the comparison data, the position of the workpiece (1) with respect to the base coordinate system.

Preferably, the algorithms of the image processing of the computer unit 5 are used for a determination of a distance a of the first camera 2 from the workpiece 1 in the z-direction, as described above (not shown in FIG. 4).

Again, optionally, pattern recognition may be performed at least in regions of the workpiece 1. In this case, the computer unit 5 and the evaluation unit 7 are configured to acquire this image data and to execute the pattern recognition process.

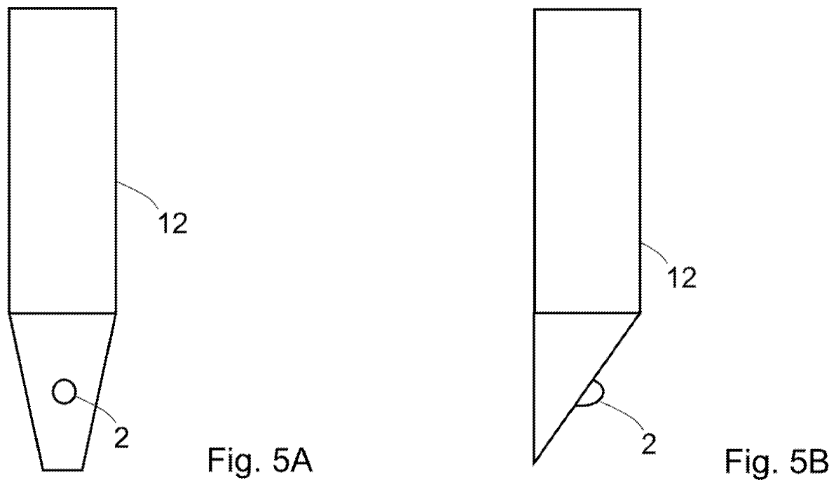

In order to protect the first camera 2 from damage caused, for example, by swarf, sparks, splashes during welding operations and the like occurring during machining of the workpiece 1, the first camera 2 may be at least partially surrounded by a sleeve 12 having an obliquely cut opening. The first camera 2 is mounted on an inner side of the sleeve 12 in the area of the obliquely cut opening (FIG. 5A). In this way, the first camera 2 is protected on one side by the part of the sleeve 12 which is elongated in the region of the opening. The remaining possible detection range of the first camera 2 is nevertheless sufficiently large (FIG. 5B).

It is understood that the foregoing description is that of the preferred embodiments of the invention and that various changes and modifications may be made thereto without departing from the spirit and scope of the invention as defined in the appended claims.

### REFERENCE SIGNS

1 Workpiece
   2 First camera
   3 Tool
   4, 4′ Reference structure
   5 Computer unit
   6 Second/additional camera
   7 Evaluation unit
   8 Control unit
   9 Drive, application
   10 Actuator
   11 Database
   12 Sleeve
   oa Optical axis
   + Reference point

What is claimed is:

1. A method for controlling a processing machine or an industrial robot, the method comprising:
acquiring image data of at least one image of a workpiece via a first camera, the first camera defining an optical axis which is parallel to an impact direction of a tool in a z-direction;
searching for a reference structure of the workpiece using the acquired image data;
determining a current actual position of at least one reference point of the reference structure in an x/y direction relative to the optical axis of the first camera;
comparing the current actual position of the reference structure with a nominal position of the reference structure;
generating control commands to place the tool to at least one area or location of the workpiece to be machined; and,
determining the current actual position of the reference structure in the z-direction of the optical axis by determining a current x/y image size of the reference structure in the acquired image data and by determining a distance of the reference structure from the first camera by comparison with the known actual x/y size of the reference structure and taking the distance of the reference structure from the first camera into account when generating the control commands.

2. The method of claim 1, wherein the reference structure is an opening defined by the workpiece, a body edge of the workpiece or an elevation of the workpiece and at least one of a length dimension, a circumferential dimension and a diameter of the reference structure is known.

3. The method of claim 1, wherein a virtual intersection point of at least two structures of the workpiece is formed and the intersection point serves as a reference point for subsequent relative movements between the workpiece and the tool.

4. The method of claim 1, wherein the image data of the workpiece are acquired via a second camera under a recording direction oblique to the z-direction, the method further comprising carrying out a pattern recognition at least in regions of the workpiece on a basis of the acquired image data.

5. The method of claim 4 further comprising:
detecting a current machining state of the workpiece via the pattern recognition; and,
comparing the detected current machining state with a nominal machining state.

6. The method of claim 1, wherein the tool is a stud welding apparatus.

7. The method of claim 1, wherein the tool is a projection welding apparatus.

8. The method of claim 1, wherein the tool is a device for screwing.

9. The method of claim 1, wherein the tool is a device for riveting.

10. A method for determining a position of a workpiece, the method comprising:
acquiring image data of at least one image of the workpiece via a first camera, wherein the camera defines an optical axis;
determining a reference structure of the workpiece on a basis of the acquired image data via an evaluation unit;
determining a current actual position of at least one reference point of the reference structure in an x/y direction relative to the optical axis of the first camera via the evaluation unit;
comparing the current actual position of the reference structure with a nominal position of the reference structure via the evaluation unit and generating comparison data; and,
inferring the position of the workpiece with respect to a base coordinate system from the comparison data via the evaluation unit.

11. The method of claim 10 further comprising:
acquiring further image data of the workpiece via at least one further camera, wherein the at least one further camera defines a further optical axis;
determining at least one further reference structure of the workpiece via the evaluation unit on a basis of the further image data acquired;
determining the current actual position of at least one reference point of the further reference structure in the x/y direction relative to the further optical axis of the further camera via the evaluation unit;
comparing the current actual position of the further reference structure with a nominal position of the further reference structure and generating further comparison data; and,
considering the further comparison data when drawing conclusions about the position of the workpiece via the evaluation unit.

12. The method of claim 10 further comprising:
determining the current actual position of the reference structure in the z-direction of the optical axis of the camera by determining a current x/y image size of the reference structure in the captured image data;
determining a distance of the reference structure from the camera by comparison with the known actual x/y size of the reference structure; and,
wherein the determined actual position of the reference structure in the z-direction is taken into account when inferring the position of the workpiece via the evaluation unit.

13. The method of claim 11 further comprising:
determining the current actual position of the reference structure and the further reference structure in the z-direction of the optical axis of the corresponding one of the camera and the further camera by determining a current x/y image size of the reference structure and the further reference structure in respective ones of the acquired image data and the further acquired image data;
determining a distance of the reference structure from the camera by comparison with the known actual x/y size of the reference structure;
determining a distance of the further reference structure from the further camera by comparison with the known actual x/y size of the further reference structure; and,
wherein the determined actual position of the reference structure and the determined actual positions of the further reference structure in the z-direction are taken into account when inferring the position of the workpiece via the evaluation unit.

14. The method of claim 10, wherein the reference structure is an opening defined by the workpiece, a body edge of the work piece or an elevation of the workpiece and at least one of a length dimension, a circumferential dimension and a diameter of the reference structure is known.

15. The method of claim 10 further comprising:
generating control commands via a control unit; and,
moving a tool to at least one area or location of the workpiece to be machined via the generated control commands.

16. The method of claim 10 further comprising:
generating control commands via a control unit; and,
interrupting or stopping a machining operation of the workpiece via the generated control commands.

17. The method of claim 10, wherein the method is for controlling an industrial robot.

18. A device for protecting a camera comprising:
a sleeve defining an obliquely cut opening; and,
said sleeve having an elongated part configured to have the camera arranged therein.
